(19) United States
(12) Patent Application Publication
(10) Pub. No.: US 2025/0254002 A1
(43) Pub. Date: Aug. 7, 2025

(54) APPARATUS AND METHODS FOR PHASE ROTATION OF PHASE TRACKING REFERENCE SIGNALS

(71) Applicant: Huawei Technologies Co., Ltd., Shenzhen (CN)

(72) Inventors: Monirosharieh Vameghestahbanati, Ottawa (CA); Huang Huang, Shenzhen (CN)

(21) Appl. No.: 19/044,131

(22) Filed: Feb. 3, 2025

Related U.S. Application Data
(63) Continuation of application No. PCT/CN2022/110333, filed on Aug. 4, 2022.

(51) Int. Cl. H04L 5/00; H04L 25/03; H04W 52/36

(52) U.S. Cl. CPC H04L 5/0051; H04L 25/03834; H04W 52/367

(57) ABSTRACT

The present disclosure relates to phase rotation of phase tracking reference signals (PTRSs). Signaling that indicates information associated with a PTRS is communicated between communication devices in a wireless communication network. Data, multiplexed with the PTRS to which a phase rotation has been applied, is transmitted or received in the wireless communication network. The information associated with the PTRS may be or include, for example, one or more of: a PTRS pattern, a physical resource block (PRB) size for transmitting the data and the PTRS, a PTRS power boost for transmitting the PTRS, a pulse shaping parameter associated with pulse shaping that is to be applied to the data and the PTRS, and a rotation angle of the phase rotation.

### CROSS-REFERENCE TO RELATED APPLICATION

This application is a continuation of International Application No. PCT/CN2022/110333, filed on Aug. 4, 2022, the disclosure of which is hereby incorporated by reference in its entirety.

### TECHNICAL FIELD

The present application relates generally to wireless communications, and more specifically to phase tracking reference signals for use in wireless communications systems.

### BACKGROUND

In some wireless communication systems, a user equipment (UE) wirelessly communicates with one or more network devices such as base stations, and may potentially communicate with one or more other UEs. A wireless communication from a UE to a network device is also referred to as an uplink communication. A wireless communication from a network device to a UE is also referred to as a downlink communication. A direct wireless communication between UEs is referred to as a device-to-device communication or a sidelink communication. Network devices may also wirelessly communicate with each other over a backhaul link.

When wireless communication occurs between two communication devices, the communication device that is transmitting a signal may be referred to as a transmitting device, and the communication device that is receiving a signal may be referred to as a receiving device. A single communication device might be both a transmitting device and a receiving device, if that communication device performs both transmission and reception. Examples of communication devices include UEs and network devices. During uplink communication, for example, a UE is the transmitting device and a network device is the receiving device. During downlink communication, the UE is the receiving device and the network device is the transmitting device. One UE is the transmitting device and another UE is the receiving device during sidelink communication, and one network device is the transmitting device and another network device is the receiving device during backhaul communication between the network devices over a backhaul link.

A reference signal may be transmitted over a wireless channel from a transmitting device to a receiving device. The reference signal may be used, for example, in any of various receiving operations such as phase noise estimation.

One solution to address ever-increasing demand of bandwidth-intense applications in mobile devices is to operate at very high frequencies, such as in mmWave bands. However, an important challenge to deal with at high frequencies is oscillator phase noise (PN). PN mainly arises from mismatch between frequencies of transmitting device and receiving device oscillators, and if not estimated, performance of a communication system can degrade significantly.

To estimate PN, a phase tracking reference signal (PTRS) may be multiplexed and transmitted with data to track phase and reduce the impairments caused by PN. On the other hand, multiplexing PTRS with data impacts its peak-to-average power ratio (PAPR) performance.

In new radio (NR), for example, when transform precoding is used, PTRS with π/2-binary phase shift keying (BPSK) modulation is multiplexed with data, which can have any modulation order. For different modulation orders of data, different power boost factors are used. Also, for different sizes of physical resource blocks (PRBs), different PTRS patterns with π/2-BPSK modulation are used. However, the PAPR performance of π/2-BPSK modulated PTRS is not always ideal for all PTRS patterns, power boost factors, different sizes of PRBs, and frequency domain spectral shaping (FDSS) filters.

Finding a reference signal approach that can consider such different factors and improve PAPR remains a challenge.

### SUMMARY

Low PAPR is important in various different applications. Embodiments disclosed herein develop techniques that can outperform the current NR PTRS scheme in terms of PAPR, while performing similarly to the NR scheme in terms of block error rate (BLER), without additional complexity. In particular, embodiments may help improve the PAPR performance of Discrete Fourier Transform-spread Orthogonal Frequency Division Multiplexing (DFT-s-OFDM) when PTRS is multiplexed with data, by considering such parameters or conditions as PTRS pattern, power boost, PRB size, and FDSS filter.

According to an aspect of the present disclosure, a method involves communicating, by a first communication device with a second communication device in a wireless communication network, signaling that indicates information associated with a PTRS. The method also involves transmitting, in the wireless communication network by the first communication device, a signal comprising data multiplexed with the PTRS to which a phase rotation has been applied.

Another method involves communicating, by a second communication device with a first communication device in a wireless communication network, signaling that indicates information associated with a PTRS. Such a method may also involve receiving, by the second communication device, a signal comprising data multiplexed with the PTRS to which a phase rotation has been applied.

An apparatus according to another aspect of the present disclosure includes a processor and a non-transitory computer readable storage medium that is coupled to the processor. The non-transitory computer readable storage medium stores programming for execution by the processor. A computer program product may be or include such a non-transitory computer readable medium storing programming.

In an embodiment, the programming includes instructions to, or to cause the processor to, communicate, between a first communication device and a second communication device in a wireless communication network, signaling that indicates information associated with a PTRS. The programming also includes instructions to, or to cause the processor to, transmit, in the wireless communication network from the first communication device, a signal comprising data multiplexed with the PTRS to which a phase rotation has been applied.

In another embodiment, the programming includes instructions to, or to cause the processor to, communicate, between a second communication device and a first communication device in a wireless communication network, signaling that indicates information associated with a PTRS; and receive, at the second communication device, a signal comprising data multiplexed with the PTRS to which a phase rotation has been applied.

In an embodiment, the processor of the apparatus is configured to cause the apparatus to perform the steps in the above instructions.

According to another aspect of the present disclosure, a system comprises a first communication device and a second communication device in communication with the first communication device. The first communication device is configured to transmit a signal comprising data multiplexed with a phase tracking reference signal (PTRS) to which a phase rotation has been applied. The second communication device is configured to receive the signal comprising the data multiplexed with the phase tracking reference signal to which the phase rotation has been applied. The second communication device is further configured to estimate, based on the received PTRS, a phase noise associated with the received signal.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating an example transmitter according to an embodiment.

FIG. 6 is a block diagram illustrating an example receiver according to an embodiment.

FIG. 7 is a block diagram illustrating an example transmitter according to another embodiment.

FIG. 8 is a block diagram illustrating an example receiver according to another embodiment.

FIG. 9 is a signal flow diagram for uplink communications according to an embodiment.

FIG. 10 is a signal flow diagram for uplink communications according to another embodiment.

FIG. 11 is a signal flow diagram for downlink communications according to an embodiment.

FIG. 12 is a signal flow diagram for sidelink communications according to an embodiment.

FIG. 13 is a signal flow diagram for sidelink communications according to another embodiment.

FIGS. 14 and 15 include plots illustrating PAPR performance comparisons.

FIG. 16 includes plots illustrating impact of phase rotation with different rotation angles on BLER performance.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

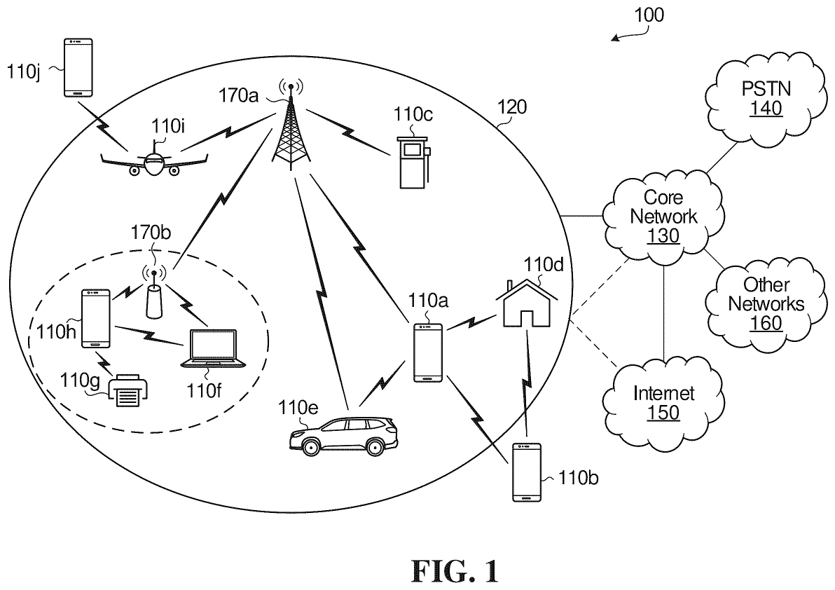

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

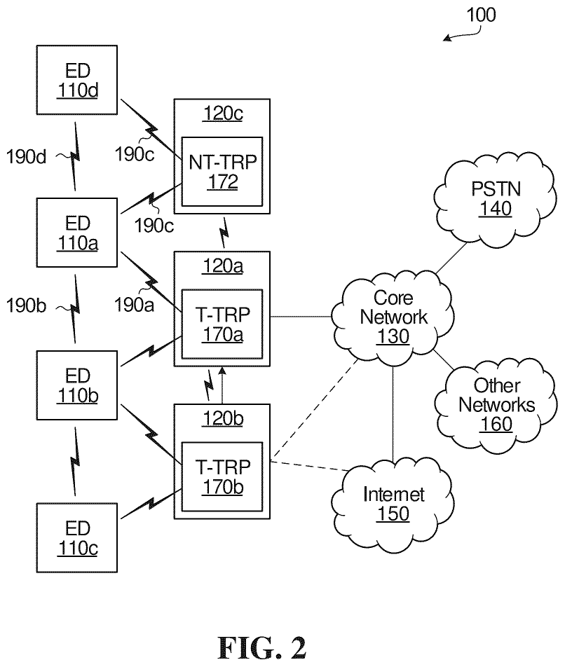

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

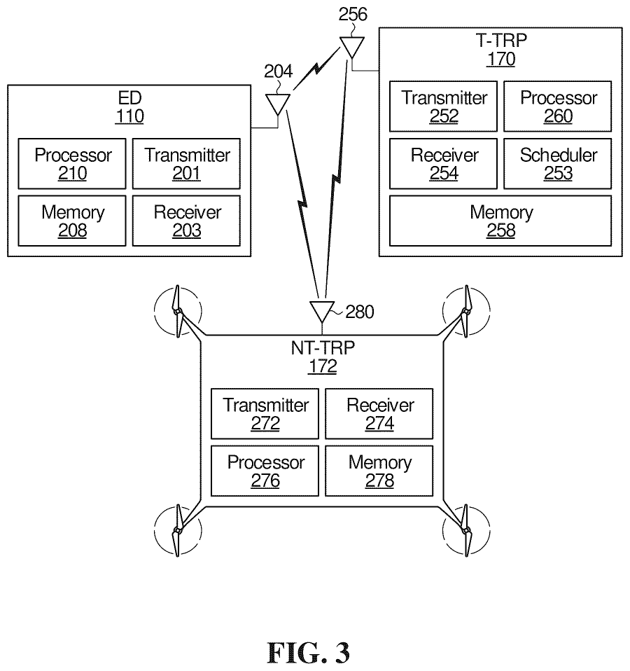

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

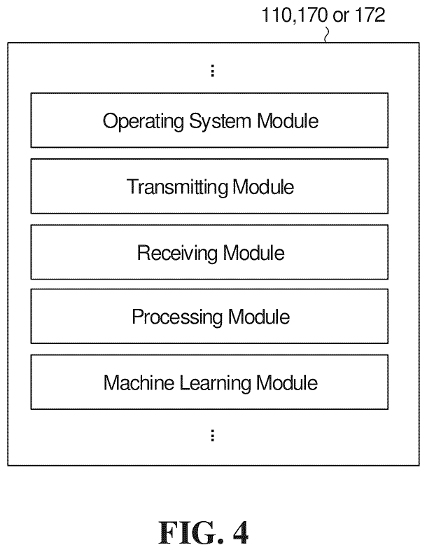

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments, which relate primarily to phase tracking reference signals.

As discussed earlier, in NR, when transform precoding is used, PTRS with π/2-BPSK modulation is multiplexed with data, which can have any modulation order. Let N denote the total number of available subcarriers (SCs) in each OFDM symbol, out of which M SCs are allocated to PTRS and the other N−M SCs are used for data transmission. After multiplexing data with PTRS, each time-domain sample is represented by dₖ, which is then spread over N SCs to produce frequency domain samples, each denoted by sₙ. In other words,

$${s}_{n} = {\sum }_{k = 0}^{N - 1} {d}_{k} {e}^{- j 2 π \frac{k}{N} n} . \qquad ( 1 )$$

The PTRS sequence for a position m before DFT precoding is generated based on the π/2-BPSK modulation according to

$${p}_{m} ( {m}^{′} ) = w ( {k}^{′} ) \frac{{e}^{{j}^{π} {/}_{2} mod ( m , 2 )}}{\sqrt{2}} [ ( 1 - 2 c ( {m}^{′} ) ) + j ( 1 - 2 c ( {m}^{′} ) ) ] , \qquad ( 2 )$$

where m denotes each PTRS sample index,

$${m}^{′} = {N}_{samp}^{group} {s}^{′} + {k}^{′} , \qquad ( 3 )$$

$${s}^{′} = 0 , 1 , ⋯ , {N}_{group}^{PTRS} - 1 ,$$

$${k}^{′} = 0 , 1 , ⋯ , {N}_{samp}^{group} - 1 ,$$

N_{group}^{PTRS} and Nₛₐₘₚ^{group} denote the number of PTRS groups in each PRB, and the number of samples in each PTRS group, respectively. Moreover, c(m′) and w(k′) represent the pseudo-random sequence and the orthogonal cover code (OCC), respectively, as defined in Section 6.4.1.2.1.2 and Section 6.4.1.2.2.2 of the following Technical Specification: 3GPP TS 38.211, “3rd Generation Partnership Project; Technical Specification Group Radio Access Network; NR; Physical channels and modulation (Release 16)”, V16.8.0 (2021-12). This Technical Specification is hereinafter referenced as the “38.211 specification”. The output of an N-DFT operation is mapped to a time-frequency resource grid, which is then transformed into time domain using an L-point Inverse Discrete Fourier Transform (IDFT) or Inverse Fast Fourier Transform (IFFT). A cyclic prefix (CP) operation is performed the time-domain signal to deal with the multipath propagation channel.

Reverse operations of these transmitter operations are performed at a receiver. A received time-domain signal is transformed back to frequency domain using an L-point Discrete Fourier Transform (DFT) or Fast Fourier Transform (FFT) after its CP portion has been discarded. The impact of channel imperfections will then be compensated by a channel equalizer. Equalized frequency domain samples will then be de-spread using an N-point IDFT to produce multiplexed time-domain noisy data and PTRS, contaminated by PN. The M noisy PTRS samples along with the original PTRS samples are used to estimate the PN. The estimated PN is then used to remove the impact of PN on the N−M data samples and output the estimated data.

Different power boost factors are used for different modulation orders of data, according to Section 6.2.3.2 of the following Technical Specification, for example: 3GPP TS 38.214, “3rd Generation Partnership Project; Technical Specification Group Radio Access Network; NR; Physical layer procedures for data (Release 16)”, V16.8.0 (2021-12). In addition, for different sizes of PRBs, different PTRS patterns with π/2-BPSK modulation are used according to the above-referenced 38.211 specification. The PAPR performance of π/2-BPSK modulated PTRS is not always ideal for all PTRS patterns, power boost factors, sizes of PRBs, and frequency domain spectral shaping (FDSS) filters, as also noted above.

Pulse shaping may be used together with bandwidth expansion in waveforms to reduce peak to average power ratio (PAPR). For example, pulse shaping and bandwidth expansion may be used in single carrier-offset quadrature amplitude modulation (SC-OQAM) or frequency domain spectral shaping with discrete Fourier transform-spread orthogonal frequency division multiplexing (FDSS-DFT-s-OFDM). Typically, pulse shaping is performed in the frequency domain, and a reduction of PAPR is achieved via bandwidth expansion and pulse shaping. This creates a tradeoff between PAPR and spectral efficiency. For example, larger bandwidth expansion, together with a larger roll off factor of pulse shape, results in lower PAPR but reduces spectral efficiency.

According to embodiments disclosed herein, phase rotation is applied to at least a PTRS. The phase rotation may also be applied to data.

For example, some embodiments involve applying a phase rotation on both data and PTRS, before transform precoding. The PTRS can be, include, or be based on a sequence with BPSK or π/2-BPSK modulation. Data can be a sequence with any type of modulation. An exact rotation angle may be configured or specified, based on one or more parameters, which may include any one or more of the following: PTRS pattern, PRB size, PTRS power boost, and an FDSS filter or pulse shaping such as a roll-off factor if root raised cosine (RRC) filtering is used.

Other embodiments involve applying a phase rotation on only PTRS, before multiplexing the PTRS with data. As in data/PTRS phase rotation embodiments, the PTRS can be, include, or be based on a sequence with BPSK or π/2-BPSK modulation, and an exact rotation angle may be configured or specified, based on one or more parameters including the examples referenced above.

Embodiments are not restricted to any specific communication applications. Features disclosed herein may be used in any of: uplink communications, downlink communications, and sidelink communications.

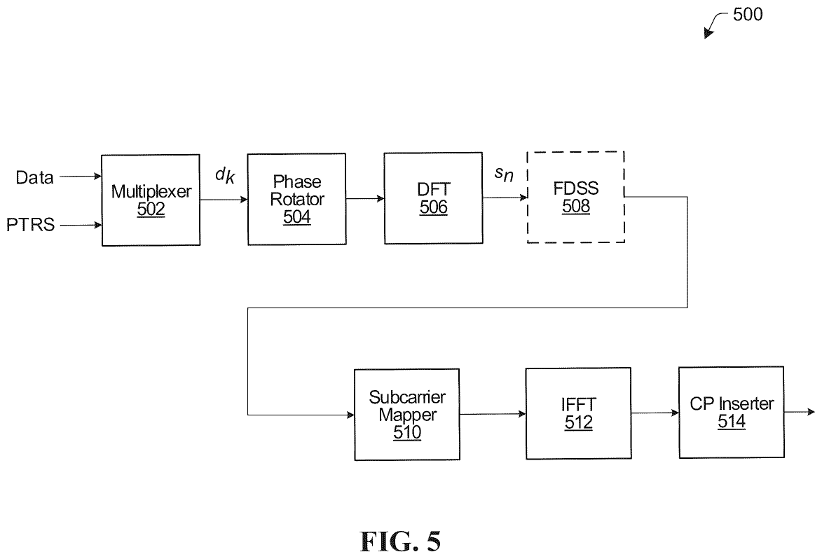

FIG. 5 is a block diagram illustrating an example transmitter according to an embodiment. The example transmitter 500 includes a multiplexer 502, a phase rotator 504, a DFT block 506, a pulse shaper 508 that applies FDSS in the example shown, a subcarrier mapper 510, an IFFT block 512, and a CP inserter 514, interconnected as shown. Other embodiments may include additional, fewer, or different elements interconnected in a similar or different way.

The elements shown in FIG. 5 may be implemented in any of various ways, such as in hardware, firmware, or one or more components that execute software. The present disclosure is not limited to any specific type of implementation, and implementation details may vary between different devices, for example. Each of the elements in the example shown is configured, by executing software for example, to implement various features or operations.

The multiplexer 502 is configured to multiplex data and PTRS. The phase rotator 504 applies or introduces phase rotation on or to the multiplexed data and PTRS. DFT block 506 is configured to convert the signal from time domain to frequency domain by performing a DFT operation, and the optional pulse shaper 508 is configured to pulse shape the frequency domain signal using a pulse shaping filter. The subcarrier mapper 510 is configured to map the data and PTRS to subcarriers. The IFFT block 512 is configured to create a time domain signal by converting the signal from frequency domain to time domain. In the example transmitter 500, the IFFT block 512 performs an IFFT operation; however, in other examples, the IFFT block 512 may be replaced by any generic IDFT block that performs an IDFT operation. The CP inserter 514 is configured to insert a CP prior to transmission.

As in another example of the above, let N again denote the total number of available SCs in each OFDM symbol, out of which M SCs are allocated to PTRS and the other N−M SCs are used for data transmission, and after multiplexing data with PTRS each time-domain sample is represented by dₖ. According to an embodiment, an N-dimensional phase rotation is applied or introduced on the multiplexed data and PTRS by the phase rotator 504, before spreading over N SCs to produce frequency domain samples. Each frequency domain sample is represented by sₙ, as follows

$${s}_{n} = {\sum }_{k = 0}^{N - 1} {r}_{k} {d}_{k} {e}^{- j 2 π \frac{k}{N} n} , \qquad ( 4 )$$

where rₖ denotes the phase rotation on each time-domain sample.

Some embodiments may implement or provide FDSS filtering, such as RRC pulse shaping for example. In such embodiments, the frequency domain samples, sₙ, are fed to the pulse shaper 508, which may also or instead be referred to as a filter or an FDSS filter for example, and are then mapped into a time-frequency resource grid by the subcarrier mapper 510. Conversion from frequency domain to time domain is then performed by the IFFT block 512 in the example shown, which may implement an L-point IFFT for example, followed by CP insertion by the CP inserter 514.

In FIG. 5, symbols that carry information bits, which are also referred to herein as data symbols that carry data or data bits, can have any of various modulation types, such as BPSK, π/2-BPSK, quadrature phase shift keying (QPSK), 16-QAM, 64-QAM, 256-QAM, among others. Moreover, symbols corresponding to PTRS can either be a π/2-BPSK-based sequence,

$${p}_{m} = \frac{{e}^{{j}^{π} {/}_{2} mod ( m , 2 )}}{\sqrt{2}} [ ( 1 - 2 {b}_{m} ) + j ( 1 - 2 {b}_{m} ) ] , \qquad ( 5 )$$

or a BPSK-based sequence,

$${p}_{m} = \frac{1}{\sqrt{2}} [ ( 1 - 2 {b}_{m} ) + j ( 1 - 2 {b}_{m} ) ] , \qquad ( 6 )$$

where pₘ and bₘ in (5) and (6) denote each PTRS sample and each PTRS bit, respectively.

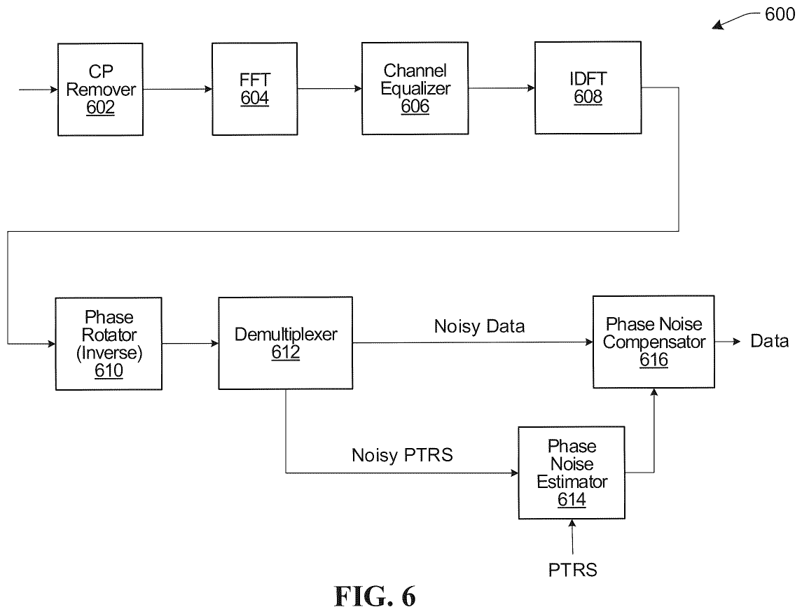

Inverse or reverse operations are performed by a receiver. FIG. 6 is a block diagram illustrating an example receiver according to an embodiment. The example receiver 600 includes a CP remover 602, an FFT block 604, a channel equalizer 606, an IDFT block 608, a phase rotator 610, a demultiplexer 612, a phase noise estimator 614, and a phase noise corrector 616, interconnected as shown. Other embodiments may include additional, fewer, or different elements interconnected in a similar or different way. For example, a receiver may include or support pulse shaping if pulse shaping is used at a transmitter.

The elements shown in FIG. 6, like those in FIG. 5, may be implemented in any of various ways, such as in hardware, firmware, or one or more components that execute software. As noted elsewhere herein, the present disclosure is not limited to any specific type of implementation, and implementation details may vary between different devices, for example.

Receiver operations for the example receiver 600 include converting a received time-domain signal to frequency domain after its CP has been removed and discarded. The impacts of channel imperfections are then compensated by channel equalization, and the equalized frequency domain samples are de-spread, using an N-point IDFT for example. An N-dimensional inverse phase rotation, which is the inverse of the phase rotation applied at a transmitter, is applied on the IDFT output to produce multiplexed time-domain noisy data and PTRS, contaminated by PN. The noisy PTRS samples, including M samples according to a transmitter example above, along with original (i.e., reference) PTRS samples locally-generated or otherwise available at the receiver, are used to estimate the PN. The estimated PN is then used to remove or at least reduce the impact of PN on the data, including N−M samples according to the transmitter example above, and the estimated data is output.

In the example receiver 600, each of the elements shown is configured, by executing software for example, to implement these features or operations. The CP remover 602 is configured to remove and discard a CP, and the FFT block 604 is configured to perform an FFT to convert the received time domain signal to frequency domain. The channel equalizer 606 is configured to perform channel equalization for removing or at least reducing impacts of channel imperfections, and the IDFT 608 is configured to perform an IDFT, such as an N-point IDFT in some embodiments, to de-spread the equalized frequency domain samples. The phase rotator 610 is configured to apply or introduce a phase rotation to the de-spread samples, and the phase rotation at a receiver is the inverse or reverse of phase rotation applied at a transmitter. The demultiplexer 612 is configured to demultiplex PTRS samples and data samples. The phase noise estimator 614 is configured to estimate phase noise based on the demultiplexed PTRS samples and original PTRS samples, and the phase noise compensator 616 is configured to correct or compensate phase noise in data symbols based on the phase noise estimated by the phase noise estimator 614, and to output estimated data.

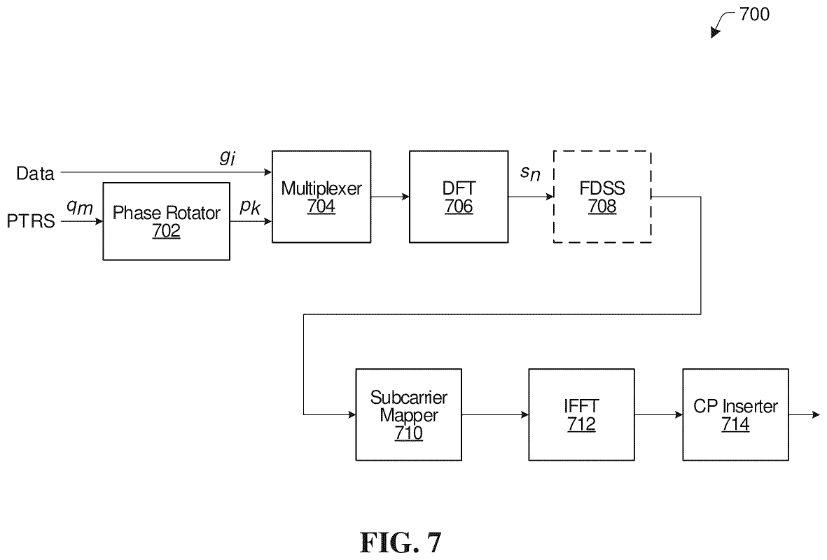

FIGS. 5 and 6 relate to embodiments in which phase rotation is applied to PTRS multiplexed with data. FIG. 7 is a block diagram illustrating an example transmitter according to another embodiment, in which phase rotation is applied to PTRS only.

The example transmitter 700 includes a phase rotator 702, a multiplexer 704, a DFT block 706, a pulse shaper 708 that applies FDSS in the example shown, a subcarrier mapper 710, an IFFT block 712, and a CP inserter 714, interconnected as shown. Other embodiments may include additional, fewer, or different elements interconnected in a similar or different way.

The elements shown in FIG. 7 may be implemented in any of various ways, such as in hardware, firmware, or one or more components that execute software. These elements may be implemented, and/or be configured to operate, in substantially the same way as similarly labelled elements in FIG. 5. The present disclosure is not limited to any specific type of implementation, and implementation details may vary between different devices, for example. Each of the elements in the example shown is configured, by executing software for example, to implement various features or operations.

The example transmitter 700 differs from the example transmitter 500 in FIG. 5 in that the phase rotator 702 applies or introduces phase rotation on or to PTRS samples. The multiplexer 704 is configured to multiplex data and rotated PTRS samples. The other elements in FIG. 7 may be configured to provide substantially the same features as described above with reference to FIG. 5, with the difference being that no phase rotation is applied to data by the phase rotator 702. DFT block 706 is configured to convert the signal from time domain to frequency domain by performing a DFT operation, and the optional pulse shaper 708 is configured to pulse shape the frequency domain signal using a pulse shaping filter. The subcarrier mapper 710 is configured to map the data and PTRS to subcarriers. The IFFT block 712 is configured to create a time domain signal by converting the signal from frequency domain to time domain. In the example transmitter 700, the IFFT block 712 performs an IFFT operation; however, in other examples, the IFFT block 712 may be replaced by any generic IDFT block that performs an IDFT operation. The CP inserter 714 is configured to insert a CP prior to transmission.

Let N again denote the total number of available SCs in each OFDM symbol, and consider an example with a data sequence of length N−M and a PTRS sequence of length M. Consistent with FIG. 7, each data sample may be denoted by gi, i∈ [symbol] , and each PTRS sample may be denoted by qₘ, m∈ [symbol] , where [symbol] ∪ [symbol] ={0, . . . , N−1}, [symbol] ∩ [symbol] =ø. A phase rotation, rₘ, is applied or introduced to or on each PTRS sample by the phase rotator 702 to produce pₘ,

$${p}_{m} = {r}_{m} {q}_{m} . \qquad ( 7 )$$

The rotated PTRS samples are then multiplexed with the data samples by the multiplexer 704 and transformed into frequency domain by the DFT block 706, using an N-DFT operation for example. Each frequency domain sample then can be expressed as

$${s}_{n} = {\sum }_{i ∈ D} {g}_{i} {e}^{- j 2 π \frac{i}{N} n} + {\sum }_{m ∈ M} {r}_{m} {q}_{m} {e}^{- j 2 π \frac{m}{N} n} . \qquad ( 8 )$$

If optional FDSS filtering, such as RRC pulse shaping, is to be applied, then the frequency domain samples, sₙ, are fed to the pulse shaper 708, which as noted at least above may also or instead be referred to as a filter or an FDSS filter. The samples are then mapped into the time-frequency resource grid by the subcarrier mapper 710, and subsequently transformed into time domain by the IFFT block 712 using an L-point IFFT for example. CP insertion is then performed by the CP inserter 714.

Symbols carrying information bits, which are also referred to herein as data or data bits, can have any modulation type, including but in no way limited to those provided above with reference to the example transmitter 700 in FIG. 7. Symbols corresponding to PTRS can either be a π/2-BPSK-based sequence,

$${p}_{m} = \frac{{r}_{m} \times {e}^{{j}^{π} {/}_{2} mod ( m , 2 )}}{\sqrt{2}} [ ( 1 - 2 {b}_{m} ) + j ( 1 - 2 {b}_{m} ) ] , \qquad ( 9 )$$

or a BPSK-based sequence,

$${p}_{m} = \frac{{r}_{m}}{\sqrt{2}} [ ( 1 - 2 {b}_{m} ) + j ( 1 - 2 {b}_{m} ) ] , \qquad ( 10 )$$

where bₘ in (9)-(10) represents each PTRS bit.

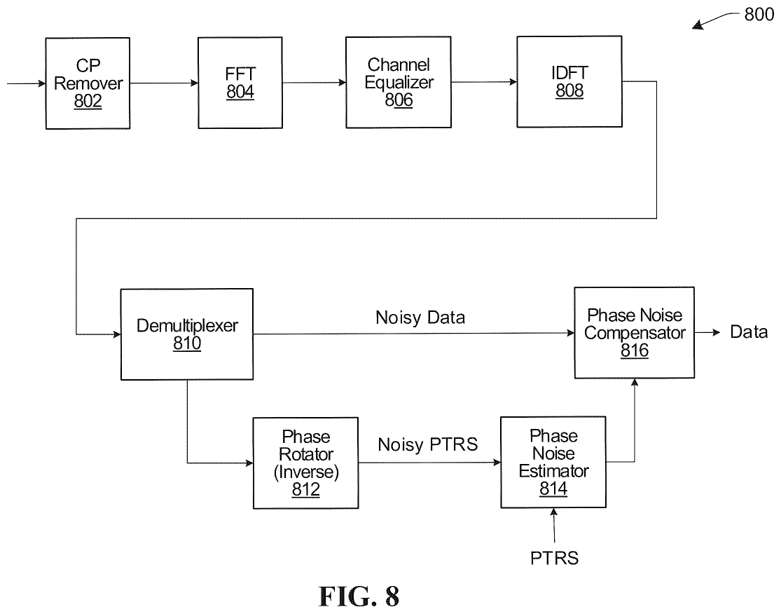

FIG. 8 is a block diagram illustrating an example receiver according to another embodiment, in which inverse or reverse operations are performed. The example receiver 800 includes a CP remover 802, an FFT block 804, a channel equalizer 806, an IDFT block 808, a demultiplexer 810, a phase rotator 812, a phase noise estimator 814, and a phase noise corrector 816, interconnected as shown. Other embodiments may include additional, fewer, or different elements interconnected in a similar or different way. For example, as noted at least above, a receiver may include or support pulse shaping if pulse shaping is used at a transmitter.

The elements shown in FIG. 8 may be implemented in any of various ways, such as in hardware, firmware, or one or more components that execute software. These elements may be implemented, and/or be configured to operate, in substantially the same way as similarly labelled elements in FIG. 6. The present disclosure is not limited to any specific type of implementation, and implementation details may vary between different devices, for example. Each of the elements in the example shown is configured, by executing software for example, to implement various features or operations.

The example receiver 800 differs from the example transmitter 600 in FIG. 6 in that the phase rotator 812 applies or introduces phase rotation on or to PTRS samples only, and not to data.

Receiver operations for the example receiver 800 include converting a received time-domain signal to frequency domain after its CP has been removed and discarded. The impacts of channel imperfections are then compensated by channel equalization, and the equalized frequency domain samples are de-spread, using an N-point IDFT, for example, to produce multiplexed time-domain noisy data and PTRS, contaminated by PN. Inverse phase rotation, which is the inverse of the phase rotation applied at a transmitter, is applied the noisy PTRS samples, including M samples according to a transmitter example above. The phase rotated noisy PTRS samples are used, along with original (i.e., reference) PTRS samples that are locally-generated or otherwise available at the receiver, to estimate the PN. The estimated PN is then used to remove or at least reduce the impact of PN on the data, including N−M data samples according to the transmitter example above, and the estimated data is output.

In the example receiver 800, each of the elements shown is configured, by executing software for example, to implement these features or operations. The CP remover 802 is configured to remove and discard a CP, and the FFT block 804 is configured to perform an FFT to convert the received time domain signal to frequency domain. The channel equalizer 806 is configured to perform channel equalization for removing or at least reducing impacts of channel imperfections, and the IDFT 808 is configured to perform an IDFT, such as an N-point IDFT in some embodiments, to de-spread the equalized frequency domain samples. The demultiplexer 810 is configured to demultiplex PTRS samples and data samples. The phase rotator 812 is configured to apply or introduce a phase rotation to the PTRS samples, and the phase rotation at a receiver is the inverse or reverse of phase rotation applied at a transmitter. The phase noise estimator 814 is configured to estimate phase noise based on the phase rotated PTRS samples and original PTRS samples, and the phase noise compensator 816 is configured to correct or compensate phase noise in data symbols based on the phase noise estimated by the phase noise estimator 814, and to output estimated data.

According to embodiments disclosed herein, a phase rotation is applied either to multiplexed data and PTRS samples, or to PTRS samples only. The phase rotation can have any of various forms, including linear or non-linear forms for example. The following is one illustrative and non-limiting example of phase rotation

$${r}_{m} = {e}^{- i φ m} . \qquad ( 11 )$$

Substituting (11) into (8) results in

$${s}_{n} = {\sum }_{i ∈ D} {g}_{i} {e}^{- j 2 π \frac{i}{N} n} + {\sum }_{m ∈ M} {e}^{- i φ m} {q}_{m} {e}^{- j 2 π \frac{m}{N} n} . \qquad ( 12 )$$

If pₘ is a π/2-BPSK-based sequence, then the NR PTRS sequence is a subset of the proposed solution with φ=0.

The exact rotation angle can be found, using exhaustive search for example, based on the following parameters:
PRB size: The PRB size may be either fixed or configurable.
PTRS pattern: PTRS patterns may depend, at least in part, upon PRB size and may be provided in a look-up table in a communications standard or specification, for example.
Power boost: Each PTRS symbol may be scaled by a power boost that is proportional to outermost data constellation symbols. In other words, power boost can be different for different modulation orders.
Pulse shaping parameters such as FDSS filter parameters: Based on a frequency-domain pulse shaping filter, the exact rotation can be different, for different roll-off factors if an RRC pulse shaping filter is used for example.

These parameters are examples of parameters that may be used in some embodiments, but more generally a rotation angle may be determined based on one or more parameters, which may include any one or more of these example parameters, and/or one or more other parameters in addition to or instead of any of these example parameters.

According to an exhaustive search approach, PAPR can be evaluated for each value of power boost (B), PRB size and its associated PTRS pattern, pulse shaping parameters if pulse shaping is applied, and each rotation angle. Evaluation of PAPR may involve computer simulation, for example. The rotation angle corresponding to minimum PAPR can then be selected as the exact rotation angle, q. The exact rotation angle can then be provided in a look-up table.

More particularly, one option for obtaining an exact rotation angle may apply when FDSS is not used. In this case, for each value of the power boost β, the exact rotation angle φ, may depend on the PRB size and its associated PTRS pattern, which can be given in a look-up table. Table 1 below shows an example of the exact rotation angle based on different PRBs and their corresponding PTRS patterns when data uses the 64-QAM constellation and PTRS uses a T/2-BPSK-based sequence with β=7/√21, which is proportional to the outermost constellation of 64-QAM. Note that a ×b PTRS (a, b∈ [symbol] , [symbol] is the set of Natural numbers) in Table 1 denotes a PTRS groups with b PTRS samples in each group.

TABLE 1
Example of exact rotation angle for DFT-s-OFDM
(no FDSS), β = 7/√21

| | 2 × 2 | 2 × 4 | 4 × 2 | 4 × 4 | 8 × 4 |
|---|---|---|---|---|---|
| PRB | PTRS | PTRS | PTRS | PTRS | PTRS |
| size | φ | φ | φ | φ | φ |
| 1 | π/16 | π/4 | 14π/16 | NA | NA |
| 2 | 0 | π/8 | 0 | π/8 | NA |
| 6 | 0 | π/8 | 0 | π/8 | 14π/16 |
| 15 | 0 | 0 | 0 | π/16 | 0 |
| 25 | 0 | 0 | 0 | π/4 | 0 |
| >30 | 0 | 0 | 0 | 0 | 0 |

If FDSS is used, then for a fixed pulse shaping parameter, such as RRC roll-off factor (α), and for each value of the power boost β, the exact rotation angle φ, may depend on the PRB size and its associated PTRS pattern, which can be given in a look-up table as illustrated by way of example in Table 2 below.

TABLE 2
Example of exact rotation angle for FDSS-DFT-s-OFDM, with RRC,
α = 0.2, β = 7/√21.

| | 2 × 2 | 2 × 4 | 4 × 2 | 4 × 4 | 8 × 4 |
|---|---|---|---|---|---|
| PRB | PTRS | PTRS | PTRS | PTRS | PTRS |
| size | φ | φ | φ | φ | φ |
| 1 | 14π/16 | NA | NA | NA | NA |
| 6 | 0 | 0 | 0 | π/16 | 0 |
| 10 | 0 | 0 | 0 | 13π/16 | 0 |
| 20 | 0 | 0 | 0 | π/8 | |
| 60 | 0 | 0 | 0 | 0 | 0 |

Another option, for a varying pulse shaping parameter, is to configure the exact rotation angle φ along with the pulse shaping parameter. These and configuration options are described in further detail elsewhere herein, at least below.

These examples of obtaining rotation angle are illustrative, and are not intended to be limiting. For example, in multiuser systems, different orthogonal cover codes (OCCs) for different UEs are used on top of the PTRS sequence of each UE. In that case, the exact rotation angle also depends on the OCC, which can be added in a look-up table and as another parameter for an exhaustive search. It should be noted that having different rotation angles for different OCCs is not expected to impact BLER performance of multiuser systems.

Regarding implementation, signaling may be exchanged between communication devices to enable a transmitting device to generate and transmit data multiplexed with a PTRS and/or to enable a receiving device to perform receiver processing to recover a PTRS and accurately estimate phase noise.

Signaling may be different, for example, for non-transparent and transparent receivers. In the case of a non-transparent receiver, the receiver has knowledge of pulse shaping used at the transmitter, from signaling that is transmitted to and received by the receiver for example. In the case of a transparent receiver, the receiver has no knowledge of pulse shaping used at the transmitter, and calculates, estimates, or otherwise determines the transmitter pulse shaping to estimate the both pulse and the channel.

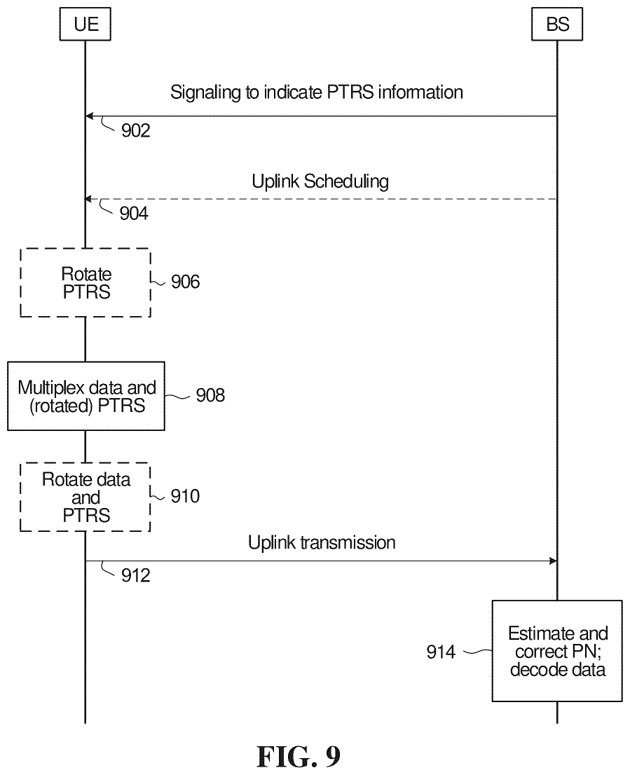

FIG. 9 is a signal flow diagram for uplink communications according to an embodiment. Features illustrated in FIG. 9 include communicating signaling at 902, which may be higher layer signaling for example, between a first communication device and a second communication device, in the form of a BS and a UE in the example shown. This communicating at 902 involves transmitting the signaling by the BS to the UE and receiving the signaling by the UE from the BS. The signaling indicates information associated with a PTRS, which is referenced as PTRS information in FIG. 9. This information associated with a PTRS may be or include, for example, any one or more of: a PTRS pattern, a PRB size for transmitting the data and the PTRS, a PTRS power boost for transmitting the PTRS, a pulse shaping parameter associated with pulse shaping that is to be applied to the data and the PTRS, and a rotation angle of phase rotation that is to be applied to at least the PTRS.

Radio resource control (RRC) signaling is one example of higher layer signaling that may be used to indicate such information.

Some embodiments may involve a scheduling or grant procedure. Signaling related to uplink scheduling is optionally communicated between the BS and the UE at 904, by the BS transmitting scheduling or grant signaling to the UE and the UE receiving the scheduling or grant signaling from the BS. This may involve, for example, downlink control information (DCI) scheduling of transmission of a transport block (TB) in uplink. Not all embodiments necessarily involve scheduling or grant procedures, and therefore uplink scheduling or grant signaling need not necessarily be communicated at 904.

As disclosed herein, phase rotation may be applied to a PTRS or to both data and a PTRS. At 906, FIG. 9 illustrates applying phase rotation only to the PTRS, and applying phase rotation to multiplexed data and PTRS is shown at 910. Multiplexing of data with the (possibly phase rotated) PTRS is illustrated at 908. The phase rotations at 906, 910 are shown in dashed lines to illustrate that phase rotation may be applied to the PTRS before the PTRS is multiplexed with data, or may be applied to multiplexed data and PTRS. Thus, prior to transmission, the phase rotation may have been applied only to the PTRS, or may have further been applied to the data.

The rotation angle of the phase rotation may be obtained in any of various ways. For example, the rotation angle may have been obtained by the BS from a look-up table that is stored at the BS. The BS may then include information that is indicative of the rotation angle in the signaling at 902. The rotation angle may have been obtained by the UE from a look-up table that is stored at the UE. Look-up tables at the UE and the BS may be involved in obtaining the rotation angle. For example, the BS may determine a specific look-up table entry corresponding to the rotation angle that is to be applied, and include information that is indicative of the table entry in the signaling at 902. The UE may then use that information to access the table entry in its own locally-stored look-up table. This example illustrates how multiple lookup tables may be involved in obtaining a rotation angle.

Look-up tables are not the only option for obtaining a rotation angle. More generally, a rotation angle may be obtained by the transmitting device. In some embodiments, the rotation angle is obtained by the transmitting device based on the information associated with the PTRS that is signaled at 902.

An uplink transmission from the UE to the BS is shown at 912, and represents one example of how data, multiplexed with a PTRS to which a phase rotation has been applied, may be communicated by a communication device in a wireless communication network. In this example, communicating the data multiplexed with the PTRS involves transmitting the data multiplexed with the PTRS by the UE to the BS, and receiving the data multiplexed with the PTRS by the BS from the UE.

At 914, FIG. 9 illustrates the BS estimating and correcting PN using the PTRS, and decoding data.

FIG. 9, and other signal flow diagrams herein, illustrate only some operations or features that may be performed or supported at a transmitting device and a receiving device. A transmitting device, for example, may perform or support other features such as any of those shown in FIG. 5 or FIG. 7 or described with reference thereto. Similarly, a receiving device may perform or support other features such as any of those shown in FIG. 6 or FIG. 8 or described with reference thereto.

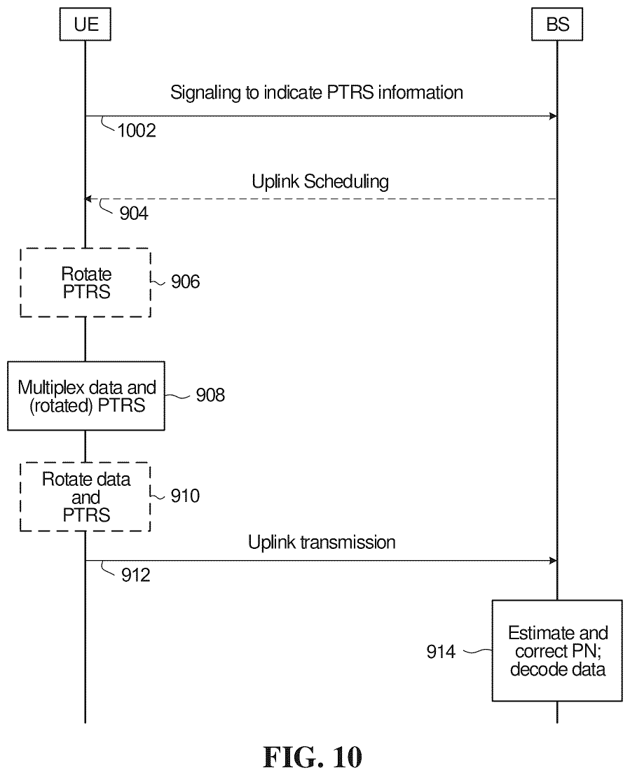

FIG. 10 is a signal flow diagram for uplink communications according to another embodiment. The example in FIG. 10 is similar to the example in FIG. 9, but involves communicating signaling at 1002 by transmitting the signaling by the UE to the BS and receiving the signaling by the BS from the UE. In some embodiments, uplink communications may involve the UE selecting or otherwise obtaining one or more parameters related to PTRS, and transmitting signaling that indicates information associated with the PTRS, at 1002. From FIGS. 9 and 10, it is believed to be apparent that signaling may be communicated in either direction, or in both directions in other embodiments, from the UE to the BS and/or from the BS to the UE.

As an example of communicating signaling from the UE to the BS at 1002, consider an embodiment in which the UE obtains a rotation angle of phase rotation that is to be applied to the PTRS, or to data and the PTRS. The UE may then transmit signaling at 1002 to indicate the rotation angle to the BS so that the BS can properly perform receiver processing.

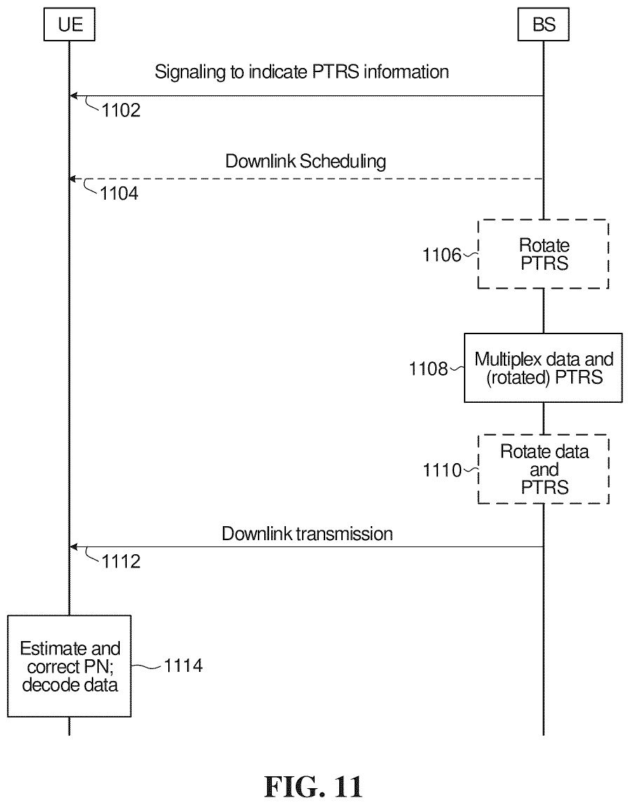

FIG. 11 is a signal flow diagram for downlink communications according to an embodiment. Features illustrated in FIG. 11 include communicating signaling at 1102, and optionally at 1104, between a BS and a UE. As in FIG. 9, this communicating at 1102, 1104 involves transmitting the signaling by the BS to the UE and receiving the signaling by the UE from the BS. The signaling at 1102 indicates information associated with a PTRS, and the optional signaling at 1104 is related to optional scheduling or grant. In the case of downlink communications, scheduling or grant may involve, for example, DCI scheduling of transmission of a TB in downlink. As noted elsewhere herein, not all embodiments necessarily involve scheduling or grant procedures. Therefore, scheduling or grant signaling need not necessarily be communicated at 1104.

In downlink, phase rotation may be applied to a PTRS or to both data and a PTRS. As shown at 1106, phase rotation may be applied only to the PTRS, and applying phase rotation to multiplexed data and PTRS is shown at 1110. Multiplexing of data with the (possibly phase rotated) PTRS is illustrated at 1108. Similar to FIG. 9, the phase rotations at 1106, 1110 are shown in FIG. 11 in dashed lines to illustrate that phase rotation may be applied to the PTRS before the PTRS is multiplexed with data, or may be applied to multiplexed data and PTRS, so that prior to transmission the phase rotation may have been applied only to the PTRS or may have further been applied to the data.

A downlink transmission from the BS to the UE is shown at 1112, and represents another example of how data multiplexed with a PTRS may be communicated in a wireless communication network. In this example, communicating the data multiplexed with the PTRS involves transmitting the data multiplexed with the PTRS by the BS to the UE and receiving the data multiplexed with the PTRS by the UE from the BS. At 1114, FIG. 11 illustrates the UE performing PN estimation and correction using the PTRS, and decoding data.

For downlink communications, it is likely that PTRS parameters will be selected or otherwise determined by the BS. However, it is possible that one or more PTRS parameters are obtained by the UE, transmitted by the UE to the BS, and received by the BS from the UE may be used by the BS in PTRS operations for downlink communications. Therefore, communicating signaling that indicates information associated with a PTRS may involve communicating signaling from a UE to a BS, even in the case of downlink communications. In other words, similar to a discussion above with reference to FIGS. 9 and 10, for downlink communications signaling as shown at 1102 in FIG. 11 may be communicated in either or both directions, and involve transmitting the signaling by the UE and receiving the signaling by the BS, transmitting the signaling by the BS and receiving the signaling by the UE, or both transmitting signaling from the BS to the UE and transmitting signaling from the UE to the BS.

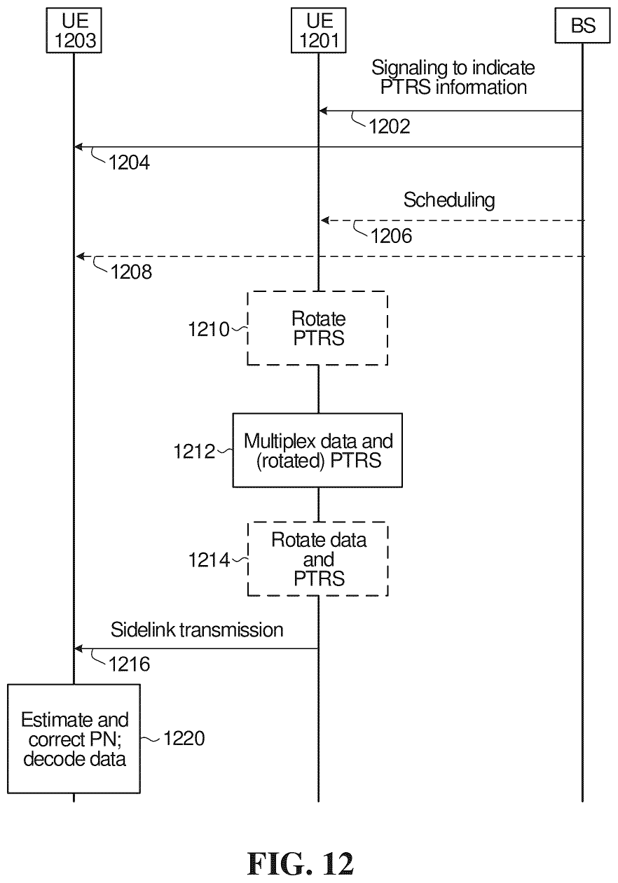

Uplink and downlink communications are described with reference to FIGS. 9 to 11. FIG. 12 is a signal flow diagram for sidelink communications according to an embodiment.

Sidelink PTRS transmission may occur between two UEs that may still be controlled by a BS. Features illustrated in FIG. 12 include communicating signaling at 1202, 1204, and optionally at 1206, 1208 between a BS and a first UE, UE 1201, and between the BS and a second UE, UE 1203. The communicating at 1202, 1206 involves transmitting the signaling by the BS to UE 1201 and receiving the signaling by UE 1201 from the BS. The communicating at 1204, 1208 involves transmitting the signaling by the BS to UE 1203 and receiving the signaling by UE 1203 from the BS. The signaling at 1202, 1204 indicates information associated with a PTRS. The signaling at 1206, 1208 is optional signaling, related to scheduling or grant. As noted elsewhere herein, not all embodiments necessarily involve scheduling or grant procedures. Therefore, scheduling or grant signaling need not necessarily be communicated at 1206, 1208.

In sidelink, as in other embodiments, phase rotation may be applied to a PTRS or to both data and a PTRS. As shown at 1210, phase rotation may be applied only to the PTRS, and applying phase rotation to multiplexed data and PTRS is shown at 1212. Multiplexing of data with the (possibly phase rotated) PTRS is illustrated at 1214. Similar to FIG. 9, the phase rotations at 1210, 1214 are shown in FIG. 12 in dashed lines to illustrate that phase rotation may be applied to the PTRS before the PTRS is multiplexed with data, or may be applied to multiplexed data and PTRS, so that prior to transmission the phase rotation may have been applied only to the PTRS or may have further been applied to the data.

A sidelink transmission from the BS to the UE is shown at 1216, and represents another example of how data multiplexed with a PTRS may be communicated in a wireless communication network. In this example, communicating the data multiplexed with the PTRS involves transmitting the data multiplexed with the PTRS by the one UE 1201 to another UE 1203 and receiving the data multiplexed with the PTRS by the UE 1203 from the UE 1201. At 1220, FIG. 12 illustrates the UE 1203 performing PN estimation and correction using the PTRS, and decoding data.

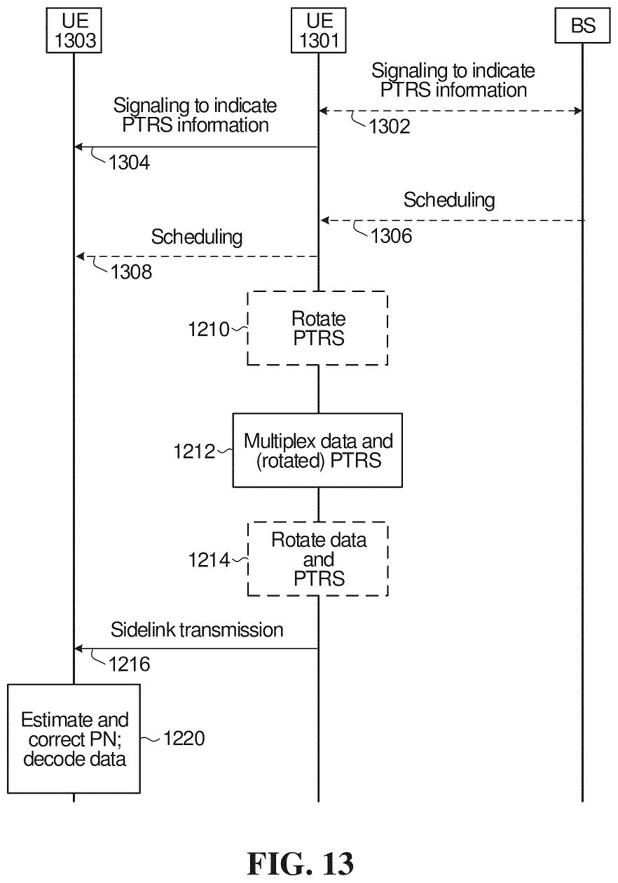

In another embodiment for sidelink communications, a transmitter UE such as UE 1201 configures one or more parameters for PTRS and sends the parameter(s) to a receiving UE such as UE 1203, via sidelink control information (SCI) or PC5 (sidelink RRC). FIG. 13 is a signal flow diagram for sidelink communications according to another embodiment, which involves communicating signaling between a UE 1301 and a UE 1303.

The example in FIG. 13 involves communicating signaling that indicates information associated with a PTRS (at 1304 and optionally at 1302), and possibly communicating signaling related to scheduling at 1306 and/or 1308. At 1304, 1308, communicating signaling involves transmitting signaling by UE 1301 to UE 1303 and receiving the signaling by UE 1303 from UE 1301. Sidelink communications may involve a transmitting UE (UE 1301 in FIG. 13) selecting or otherwise obtaining PTRS pulse shaping and/or phase rotation parameters for example, and transmitting signaling to a receiving UE (UE 1303 in FIG. 13).

Embodiments that involve communicating signaling between UEs as shown by way of example in FIG. 13 may or may not also involve communicating signaling between a BS and a UE. Optional features are shown in FIG. 13 at 1302, 1306. For sidelink communications, PTRS-related operations may remain transparent to the BS, and the BS need not be informed of PTRS parameters or communicate such parameters to UE 1301 at 1302, or communicate signaling for scheduling at 1306.

The other features shown in FIG. 13 may be substantially the same as in FIG. 12.

FIGS. 9 to 13 are illustrative of various embodiments. More generally, a method consistent with the present disclosure may involve communicating signaling between a first communication device and a second communication device in a wireless communication network. From the perspective of one of these communication devices, for example, such a method performed by a first (or second) communication device involves communicating signaling with a second (or first) communication device. The signaling indicates information associated with a PTRS.

Communicating signaling may involve transmitting the signaling, receiving the signaling, or both. Similarly, communicating data multiplexed with the PTRS, with a phase rotation having been applied to at least the PTRS, may involve transmitting the data multiplexed with the PTRS, receiving the data multiplexed with the PTRS, or both. For example, FIGS. 9 to 13 illustrate embodiments in which communicating signaling involves the following, any one or more of which may be provided or supported by different types of communication devices such as UEs or base stations:
receiving, by a UE, signaling from a BS or another UE, as shown by way of example at 902, 904, 1004, 1102, 1104, 1202, 1204, 1206, 1208, 1302, 1304, 1306, 1308;
receiving, by a BS, signaling from a UE, as shown by way of example at 1002, 1302;
transmitting, by a UE, signaling to a BS and/or to another UE, as shown by way of example at 1002, 1302, 1304, 1308;
transmitting, by a BS, signaling to one or more UEs, as shown by way of example at 902, 904, 1102, 1104, 1202, 1204, 1206, 1208, 1302, 1306.

These examples illustrate that communicating signaling may involve transmitting the signaling by any of various types of first communication device such as a UE or a base station or other network device, to any of various types of second communication device such as a UE or a base station or other network device. Communicating signaling may also or instead involve receiving the signaling at any of various types of first communication device such as a UE or a base station or other network device, from any of various types of second communication device such as a UE or a base station or other network device.

A method may also involve transmitting, by or from a first communication device or a second communication device for example, data multiplexed with the PTRS to which a phase rotation has been applied, as disclosed herein. Some embodiments involve receiving, by or at a second communication device or a first communication device for example, data multiplexed with the PTRS to which a phase rotation has been applied.

Similar to communicating signaling, communicating data multiplexed with a PTRS may involve transmitting the data multiplexed with the PTRS, by any of various types of communication device such as a UE or a base station or other network device, to any of various types of communication device such as a UE or a base station or other network device. Communicating data multiplexed with a PTRS may also or instead involve receiving the data multiplexed with the PTRS at any of various types of communication device such as a UE or a base station or other network device, from any of various types of communication device such as a UE or a base station or other network device. Examples of communicating a data multiplexed with a PTRS, including transmitting and receiving examples, are shown in FIGS. 9 to 13 at 912, 1112, 1216.

A receiver or intended receiver (or receiving device) of data multiplexed with a PTRS may transmit or receive signaling before data multiplexed with the PTRS is received. In FIG. 9, for example, the BS is the intended receiver and may transmit signaling at 902, and optionally at 904, before receiving the data multiplexed with the PTRS at 912. In FIG. 10, the BS is the intended receiver of the data multiplexed with the PTRS and may receive signaling at 1002, and optionally transmit and/or receive signaling at 1004, before receiving the data multiplexed with the PTRS at 912. In FIG. 11, the UE is the intended receiver of the PTRS and may receive signaling at 1102, and optionally at 1104, before receiving the data multiplexed with the PTRS at 1112. In FIGS. 12 and 13, UE 1203 or UE 1303 is the intended receiver of data multiplexed with a PTRS and may receive signaling at 1204 and optionally at 1208 (from the BS) or at 1304 and optionally at 1308 (from UE 1301) before receiving data multiplexed with the PTRS at 1216.

Similarly, a transmitter or intended transmitter (or transmitting device) of data multiplexed with a PTRS may transmit or receive signaling before the data multiplexed with the PTRS is transmitted. In FIG. 9, for example, the UE is the transmitter of the data multiplexed with the PTRS and may receive signaling at 902 and optionally at 904 before transmitting the data multiplexed with the PTRS at 912. The UE is also the transmitter of the data multiplexed with the PTRS in FIG. 10, but may transmit signaling at 1002 and optionally transmit and/or receive signaling at 1004 before transmitting the data multiplexed with the PTRS at 912. In FIG. 11, the BS is the transmitter of the data multiplexed with the PTRS and may transmit signaling at 1102 and optionally at 1104 before transmitting the data multiplexed with the PTRS at 1112. In FIGS. 12 and 13, UE 1201 or UE 1301 is the transmitter of the data multiplexed with the PTRS and may receive signaling at 1202 and optionally 1206, 1302, 1306 (from the BS), or transmit signaling at 1304 and optionally at 1308 (to the UE 1303) and optionally at 1302 (to the BS) before transmitting the data multiplexed with the PTRS at 1216.

In some embodiments, both signaling and data multiplexed with the PTRS are communicated between a transmitter and an intended receiver of the data multiplexed with the PTRS, as in FIGS. 9 to 11 and between UE 1301 and UE 1303 in FIG. 13. Thus, in the context of communicating signaling between a first communication device and a second communication device, in such embodiments communicating the data multiplexed with the PTRS involves communicating the data multiplexed with the PTRS between the first communication device and the second communication device.

Signaling and data multiplexed with a PTRS need not necessarily be communicated between the same devices. Consider FIG. 12 as an example. Signaling is communicated between the BS and UE 1201 at 1202 and between the BS and UE 1203 at 1204, but the data multiplexed with the PTRS is communicated between UE 1201 and UE 1203 at 1216. This is illustrative of embodiments in which signaling and data multiplexed with a PTRS are not communicated between the same devices. In the context of communicating signaling by a first communication device with a second communication device, in such embodiments communicating data multiplexed with a PTRS may involve communicating the data multiplexed with the PTRS by or from the first communication device (or the second communication device) and a third communication device in the wireless communication network.

These are all illustrative of examples of communicating signaling and communicating data multiplexed with a PTRS.

These method examples are illustrative and non-limiting embodiments, and other embodiments may include additional or different features disclosed herein.

For example, any one or more of the following features may be provided, in any of various combinations:
information associated with the PTRS may be or include any one or more of: a PTRS pattern, a PRB size for transmitting the data and the PTRS, a PTRS power boost for transmitting the PTRS, a pulse shaping parameter associated with pulse shaping that is to be applied to the data and the PTRS, and a rotation angle of the phase rotation;
the rotation angle may have been obtained from a look-up table;
the rotation angle of the phase rotation may have been obtained, by the first communication device for example, based on the information associated with the PTRS;
the rotation angle having been obtained, by the first communication device for example, from a look-up table that is stored at the first communication device;
the phase rotation may have been applied only to the PTRS;
the phase rotation may further have been applied to the data;
the PTRS may be or include a BPSK-based sequence of symbols or a π/2-BPSK-based sequence of symbols;
the data may be or include a BPSK-based sequence of symbols, a n/2-BPSK-based sequence of symbols, a QPSK-based sequence of symbols, a 16-QAM-based sequence of symbols, a 64-QAM-based sequence of symbols, or a 256-QAM-based sequence of symbols;
communicating the signaling may involve transmitting the signaling from the first communication device to the second communication device;
communicating the signaling may involve receiving the signaling by the first communication device from the second communication device;
communicating the signaling may involve transmitting the signaling from the second communication device to the first communication device;
communicating the signaling may involve receiving the signaling by the second communication device from the first communication device;
transmitting the data multiplexed with the PTRS may involve transmitting the data multiplexed with the PTRS by the first communication device to the second communication device;
transmitting the data multiplexed with the PTRS may involve transmitting the data multiplexed with the PTRS by the first communication device to a third communication device in the wireless communication network;
receiving the data multiplexed with the PTRS may involve receiving the data multiplexed with the PTRS by the second communication device from the first communication device;
receiving the data multiplexed with the PTRS comprises receiving the data multiplexed with the PTRS by the second communication device from a third communication device in the wireless communication network.

Other embodiments are also possible.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to, or to cause a processor to, communicate, between a first communication device and a second communication device in a wireless communication network, signaling that indicates information associated with a PTRS; and transmit, in the wireless communication network from the first communication device, data multiplexed with the PTRS to which a phase rotation has been applied. In another embodiment, programming stored in or on a non-transitory computer readable storage medium may include instructions to, or to cause a processor to, communicate, between a second communication device and a first communication device in a wireless communication network, signaling that indicates information associated with a PTRS; and receive, at the second communication device, data multiplexed with the PTRS to which a phase rotation has been applied.

Embodiments related to apparatus or non-transitory computer readable storage media may include any one or more of the following features, for example, which are also discussed elsewhere herein:
information associated with the PTRS may be or include any one or more of: a PTRS pattern, a PRB size for transmitting the data and the PTRS, a PTRS power boost for transmitting the PTRS, a pulse shaping parameter associated with pulse shaping that is to be applied to the data and the PTRS, and a rotation angle of the phase rotation;
the rotation angle may have been obtained from a look-up table;
the rotation angle of the phase rotation may have been obtained, at the first communication device for example, based on the information associated with the PTRS;
the rotation angle having been obtained, at the first communication device for example, from a look-up table that is stored at the first communication device;
the phase rotation may have been applied only to the PTRS;
the phase rotation may further have been applied to the data;
the PTRS may be or include a BPSK-based sequence of symbols or a π/2-BPSK-based sequence of symbols;
the data may be or include a BPSK-based sequence of symbols, a π/2-BPSK-based sequence of symbols, a QPSK-based sequence of symbols, a 16-QAM-based sequence of symbols, a 64-QAM-based sequence of symbols, or a 256-QAM-based sequence of symbols;
the programming may include instructions to, or to cause a processor to, communicate the signaling by transmitting the signaling from the first communication device to the second communication device;
the programming may include instructions to, or to cause a processor to, communicate the signaling by receiving the signaling at the first communication device from the second communication device;
the programming may include instructions to, or to cause a processor to, communicate the signaling by transmitting the signaling from the second communication device to the first communication device;
the programming may include instructions to, or to cause a processor to, communicate the signaling by receiving the signaling at the second communication device from the first communication device;
the programming may include instructions to, or to cause a processor to, transmit the data multiplexed with the PTRS from the first communication device to the second communication device;
the programming may include instructions to, or to cause a processor to, transmit the data multiplexed with the PTRS from the first communication device to a third communication device in the wireless communication network;
the programming may include instructions to, or to cause a processor to, receive the data multiplexed with the PTRS at the second communication device from the first communication device;
the programming may include instructions to, or to cause a processor to, receive the data multiplexed with the PTRS at the second communication device from a third communication device in the wireless communication network.

An effect of applying a phase rotation to multiplexed PTRS and data or only to PTRS based on an optimum rotation angle is that transitions between consecutive symbols will be smoother. As such, the overall PAPR (PAPR of data symbols and PTRS symbols, and not just data symbols) is improved relative to other approaches that do not involve applying phase rotation. BLER performance with phase rotation is comparable to that of non-rotation approaches, and adding phase rotation as disclosed herein does not impact communication standard or specification compatibility. For example, embodiments remain compliant with the specifications that are referenced herein. Also, embodiments involve a phase rotation and accordingly implementation complexity is very low.

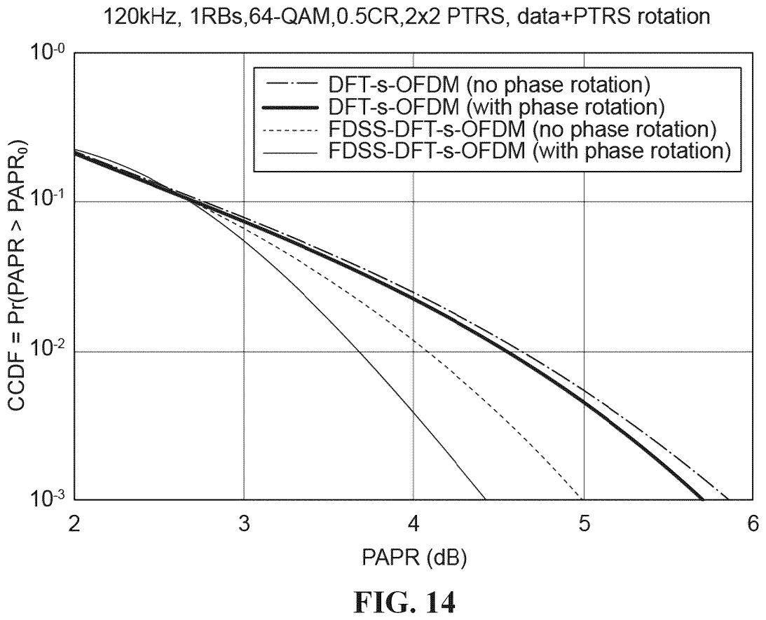

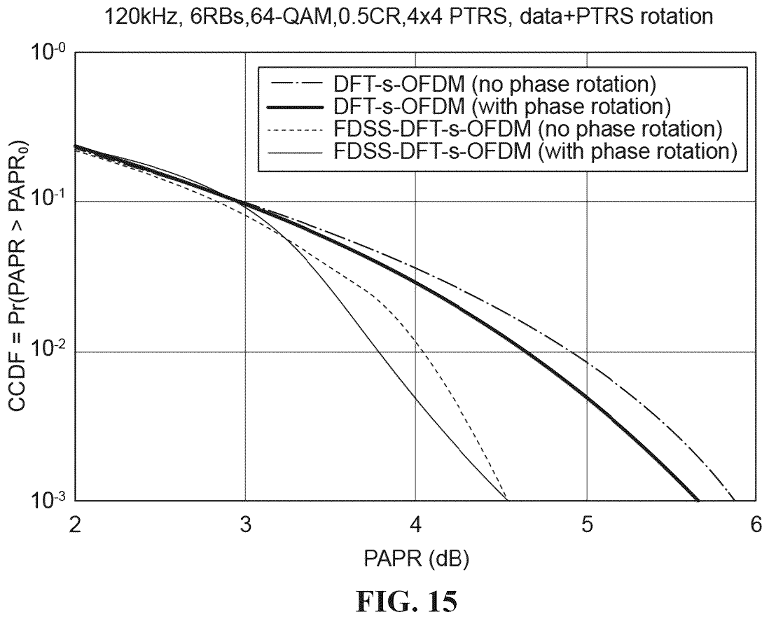

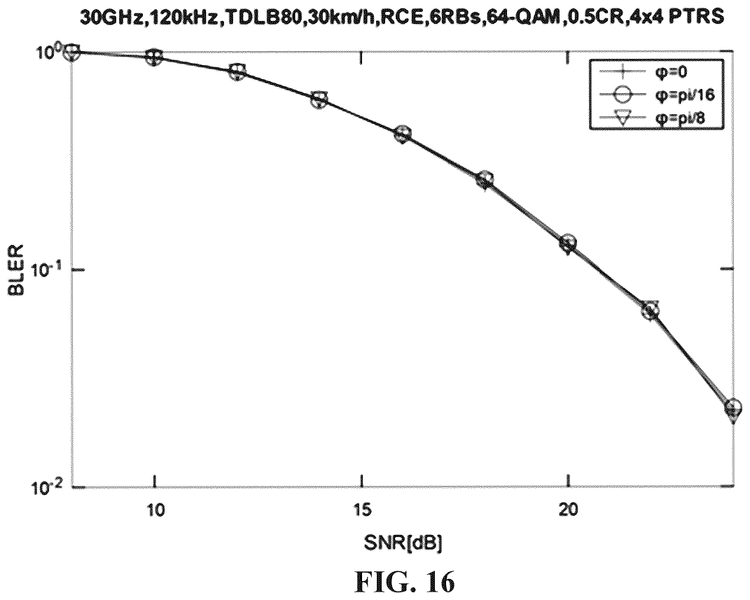

FIGS. 14 and 15 include plots illustrating PAPR performance comparisons, between example embodiments and approaches that do not involve phase rotation as disclosed herein. CCDF in FIGS. 14 and 15 refers to complementary cumulative distribution function. The plots in FIG. 14 are based on simulation results, for a PRB size of 1, 2×2 PTRS pattern, β=7/√21, and other simulation conditions as indicated at the top of the figure. The plots in FIG. 15 are also based on simulation results, but for a PRB size of 6, 4×4 PTRS pattern, β=7/√21, and other simulation conditions as indicated at the top of the figure. FIGS. 14 and 15 provide PAPR performance comparisons for DFT-s-OFDM and FDSS-DFT-s-OFDM waveforms, and show that the simulated embodiments can result in up to 0.4 dB gain, relative to the simulated approaches without phase rotation, to achieve CCDF of 10-2. FIG. 16 includes plots illustrating impact of phase rotation, with different rotation angles, on BLER performance. In FIG. 16, the plots are again based on simulations, under the simulation conditions as indicated at the top of the figure, and it can be observed that BLER performance of the simulated embodiments does not depend on rotation angle, and performance is consistent between different rotation angles.

Although the examples in FIGS. 14 to 16 relate to simulations of embodiments that involve phase rotation of both data and PTRS, it is expected that PTRS-only phase rotation embodiments will yield similar performance results.

It should also be noted that the examples in FIGS. 14 to 16 are based on simulations under particular simulation conditions. Performance of these or other embodiments, in simulations or in practice, may be similar to or different from the examples shown.

In embodiments that involve applying phase rotation on both data and PTRS, before transform precoding, PTRS can be or include a sequence with BPSK or π/2-BPSK modulation, and data can be a sequence with any types of modulation. Configuration or specification of an exact rotation angle may be based on parameters related to, for example, PTRS pattern, PRB size, PTRS power boost, and pulse shaping in some embodiments.

Similarly, with phase rotation applied on only PTRS, before multiplexing with data, PTRS can be or include a sequence of BPSK or π/2-BPSK modulation, and configuration or specification of an exact rotation angle in some embodiments may be based on parameters related to, for example, PTRS pattern, PRB size, PTRS power boost, and pulse shaping.

Although described primarily in the context of data and PTRS, embodiments disclosed herein may be applied to any reference signals that can be multiplexed with data, or even different reference signals with different magnitude levels that are multiplexed with each other. More generally, embodiments may be applied to signals that are to be multiplexed together, and have different modulation orders, different magnitudes, or both,

Low PAPR may be of interest in different contexts or application scenarios, and accordingly embodiments disclosed herein may be used in any of various scenarios, including any of uplink, downlink, and sidelink communications in 5G cellular systems and beyond. Embodiments may also or instead be beneficial for application in satellite communications, WiFi systems, and/or other scenarios.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
communicating, by a first communication device with a second communication device in a wireless communication network, signaling that indicates information associated with a phase tracking reference signal (PTRS); and
transmitting, in the wireless communication network by the first communication device, a signal comprising data multiplexed with the PTRS, a phase rotation having been applied to at least the PTRS.

2. The method of claim 1, wherein the information associated with the PTRS indicates one or more of: a PTRS pattern, a physical resource block (PRB) size for transmitting the data and the PTRS, or a PTRS power boost for transmitting the PTRS.

3. The method of claim 1, wherein the information associated with the PTRS indicates a pulse shaping parameter associated with pulse shaping that is to be applied to the data and the PTRS.

4. The method of claim 1, wherein the information associated with the PTRS indicates a rotation angle of the phase rotation.

5. The method of claim 1, further comprising:
before the transmitting, obtaining, by the first communication device, a rotation angle of the phase rotation based on the information associated with the PTRS.

6. A method comprising:
communicating, by a second communication device with a first communication device in a wireless communication network, signaling that indicates information associated with a phase tracking reference signal (PTRS); and
receiving, by the second communication device, a signal comprising data multiplexed with the PTRS, a phase rotation having been applied to at least the PTRS.

7. The method of claim 6, wherein the information associated with the PTRS indicates one or more of: a PTRS pattern, a physical resource block (PRB) size for transmitting the data and the PTRS, or a PTRS power boost for transmitting the PTRS.

8. The method of claim 6, wherein the information associated with the PTRS indicates a pulse shaping parameter associated with pulse shaping that is to be applied to the data and the PTRS.

9. The method of claim 6, wherein the information associated with the PTRS indicates a rotation angle of the phase rotation.

10. The method of claim 6, a rotation angle of the phase rotation having been obtained by the first communication device based on the information associated with the PTRS.

11. An apparatus comprising:
at least one processor; and
a non-transitory computer readable storage medium, coupled to the at least one processor, storing programming for execution by the at least one processor, the programming including instructions to cause the apparatus to:
communicate, between the apparatus and a second communication device in a wireless communication network, signaling that indicates information associated with a phase tracking reference signal (PTRS); and
transmit, in the wireless communication network, a signal comprising data multiplexed with the PTRS, a phase rotation having been applied to at least the PTRS.

12. The apparatus of claim 11, wherein the information associated with the PTRS indicates one or more of: a PTRS pattern, a physical resource block (PRB) size for transmitting the data and the PTRS, or a PTRS power boost for transmitting the PTRS.

13. The apparatus of claim 11, wherein the information associated with the PTRS indicates a pulse shaping parameter associated with pulse shaping that is to be applied to the data and the PTRS.

14. The apparatus of claim 11, wherein the information associated with the PTRS indicates a rotation angle of the phase rotation.

15. The apparatus of claim 11, the instructions further causing the apparatus to:
before transmitting the signal, obtain a rotation angle of the phase rotation based on the information associated with the PTRS.

16. An apparatus comprising:
at least one processor; and
a non-transitory computer readable storage medium, coupled to the at least one processor, storing programming for execution by the at least one processor, the programming including instructions to cause the apparatus to:
communicate, between the apparatus and a first communication device in a wireless communication network, signaling that indicates information associated with a phase tracking reference signal (PTRS); and
receive a signal comprising data multiplexed with the PTRS, a phase rotation having been applied to at least the PTRS.

17. The apparatus of claim 16, wherein the information associated with the PTRS indicates one or more of: a PTRS pattern, a physical resource block (PRB) size for transmitting the data and the PTRS, or a PTRS power boost for transmitting the PTRS.

18. The apparatus of claim 16, wherein the information associated with the PTRS indicates a pulse shaping parameter associated with pulse shaping that is to be applied to the data and the PTRS.

19. The apparatus of claim 16, wherein the information associated with the PTRS indicates a rotation angle of the phase rotation.

20. The apparatus of claim 16, a rotation angle of the phase rotation having been obtained at the first communication device based on the information associated with the PTRS.
